(19) United States
(12) Patent Application Publication
(10) Pub. No.: US 2010/0180647 A1
(43) Pub. Date: Jul. 22, 2010

(54) LOCKING APPARATUS

(76) Inventor: Dae-ung Yoon, Joul La Nam-Do (KR)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(21) Appl. No.: 12/601,202

(22) PCT Filed: May 14, 2008
(86) PCT No.: PCT/KR2008/002666

§ 371 Date: Nov. 20, 2009

(30) Foreign Application Priority Data
May 22, 2007 (KR) 10-2007-0049931
Sep. 21, 2007 (KR) 10-2007-0096361
Apr. 4, 2008 (KR) 10-2008-0031448

(51) Int. Cl. E05B 73/00

(52) U.S. Cl. 70/58

(57) ABSTRACT

A locking apparatus having a clipping mechanism is provided. The locking apparatus includes: a main body including upper and lower pressing portions defining a gripping space and a support or connecting member supporting or connecting the upper and lower pressing portions and providing a gripping force to the upper and lower pressing portions; an opening/closing member that is affixed to the main body and transmits a force to the upper and lower pressing portions so that the upper and lower pressing portions may open; and a cover member enclosing the main body and controlling a force for opening the upper and lower pressing portions. The locking apparatus can be widely applied to usefully lock or secure personal articles vulnerable to privacy intrusions such as a bag, a notebook, a planner/diary, and a book and an electronic dictionary, a gaming machine or other electronic devices vulnerable to theft.

### FIELD OF THE DISCLOSURE

The present disclosure relates to a locking apparatus, and more particularly, to a locking apparatus with a clipping mechanism, which can lock a personal article vulnerable to privacy intrusions or theft, e.g., a bag, a planner/diary, a book, an electronic dictionary, a game machine, or the like, or can secure the personal article against theft. The present disclosure also relates to a locking apparatus with a clipping mechanism, which can be used as an accessory of an article requiring its use.

### BACKGROUND OF THE DISCLOSURE

In general, bags, handbags, diaries, notebooks are equipped with separate locking apparatuses to prevent privacy intrusion. A locking apparatus is typically integrated with a main body of such an article.

Some examples of locking apparatuses are a zipper locking apparatus, a lock for use with a planner/diary, and a locking apparatus for use with a diary book, as proposed in Korean Utility Model Registration Nos. 0272963, 0379789, and 0343960.

The zipper locking apparatus is configured such that a locking member that is tightened with an elastic member disposed at an end of a zipper is clamped into a bore in a zipper pull tab. Since the zipper locking apparatus is attached onto clothes or bags, it is relatively inconvenient to use.

A diary book with a lock assembly is disclosed in Korean Utility Model Laid-open Application No. 1998-68731. The disclosed diary book with a lock assembly is configured to remain closed by inserting a latch member on a rear cover member through an insertion hole perforated in a clamp member on a front cover member and locking a locking member into a clamp hole of the latch member.

The diary book with a lock assembly having the above configuration can protect privacy by prohibiting other people from seeing the contents of the diary book. However, since the lock assembly is incorporated into the diary book, the lock assembly is not reusable once the diary book is used up. Further, another drawback is that the price of diary book may increase due to the necessity of separately providing the lock assembly.

A further example is a clamper locking apparatus disclosed in Korean Utility Model Registration No. 20-0310367. The clamper locking apparatus is configured such that one handle of a clamper is removably affixed to an end of a body of the clamper locking apparatus. More specifically, the end of the body is bent to have a plurality of grooves of different widths. The handle of the clamper that will be removably affixed to the end of the body has a side with a plurality of bosses corresponding to the grooves.

The locking apparatus using a clamper is configured such that one handle of the clamper is removed to make the main body of the clamper incapable of being opened. Due to the above configuration, the clamper locking apparatus renders several problems including inconvenience in use, a poor design level, and low market quality.

### SUMMARY OF THE DISCLOSURE

To solve the above problems, it is an object of the present disclosure to provide a locking apparatus having a clipping mechanism adapted to lock or securing against theft personal articles vulnerable to privacy intrusions, such as a bag, notebook, planner/diary, wallet, and book, or home appliances and electronic devices vulnerable to theft, such as an electronic dictionary, a gaming machine, a digital camera, a walkman, or the like.

It is another object of the present disclosure to provide a locking apparatus having a simplified clipping mechanism that can be attached as an accessory of an article and has flexibility in selecting a wide range of alternative materials and designs while providing a sense of physical, psychological security to consumers and improved market quality.

### TECHNICAL SOLUTION

According to an aspect of the present disclosure, there is provided a locking apparatus having a clipping mechanism including: a main body including upper and lower pressing portions defining a gripping space and a support or connecting member supporting or connecting the upper and lower pressing portions and providing a gripping force to the upper and lower pressing portions; an opening/closing member that is affixed to the main body and transmits a force to the upper and lower pressing portions so that the upper and lower pressing portions may open; and a cover member enclosing at least a portion of the inside and outside of the main body and controlling a force for opening the upper and lower pressing portions to the main body.

In the present disclosure, the opening/closing member may further comprise a leverage-type lever member disposed on at least one of the upper and lower pressing portions so as to easily apply a force to the opening/closing member.

The locking member may comprise a door that is disposed in the cover member so as to control the operation of the cover member and opens or closes only a portion of the cover member so that only a portion of the main body is exposed and a lock mounted at a location where the cover member interacts with the door so as to lock opening/closing of the door. In addition, the locking apparatus may further comprise a friction-induced portion that is disposed on the upper and lower pressing portions so as to prevent the upper and lower pressing portions from sliding or being separated from a portion of an article being bound. The friction-induced portion consists of first and second pads that are disposed on opposing inner surfaces of the upper and lower pressing portions and prevents sliding when binding an article.

An elastic reinforcement member may be provided in the main body in order to increase the gripping force of the upper and lower pressing portions. The cover member may be provided with a chain for connecting the article.

According to another aspect of the present disclosure, there is provided a locking apparatus having a clipping mechanism, the device comprising: a main body including upper and lower pressing portions defining a gripping space and a support supporting the upper and lower pressing portions and providing a gripping force to the upper and lower pressing portions; an opening/closing member that is affixed to the main body, transmits a force to the upper and lower pressing portions so that the upper and lower pressing portions may open, and further includes a lever member disposed on the upper and lower pressing portions so as to easily apply a force to the opening/closing member; and a locking member that is disposed at a location where the main body interacts with the lever member and secures the lever member, wherein the locking member includes a lock disposed on the main body and the lever member and secures and locks the lever member, the lock includes a lock body having a lock/release portion on an inner side thereof of a sufficient size to control the operation of the lever member and a latch member extending along an axis of the lock/release portion.

Alternatively, the main body may include a main body including upper and lower pressing portions defining a gripping space and connecting bars connecting the upper and lower pressing portions with each other and a pressing member affixed to the main body so as to provide a gripping force to the upper and lower pressing portions. The main body having the above configuration may be used instead of a main body having a self-elastic gripping force.

### BRIEF DESCRIPTION OF THE DRAWINGS

FIG. 1 is an exploded perspective view of a locking apparatus having a clipping mechanism according to an embodiment of the present disclosure;

FIG. 2 is a perspective view of a main body in the locking apparatus of FIG. 1;

FIGS. 3 through 6 are perspective views of friction-induced portions having first and second protrusions according to embodiments of the present disclosure;

FIG. 7 is a perspective view of a friction-induced portion having first and second pads according to another embodiment of the present disclosure;

FIG. 8 is a perspective view of a friction-induced portion having a combination of protrusions and pads according to another embodiment of the present disclosure;

FIG. 9 is a side view of a friction-induced portion having a combination of protrusions and pads according to another embodiment of the present disclosure;

FIG. 10 is a perspective view of a friction-induced portion with adjusting screws according to another embodiment of the present disclosure;

FIG. 11 is a perspective view of a friction-induced portion having magnetic substances fixed thereon according to another embodiment of the present disclosure;

FIG. 12 is a perspective view of a friction-induced portion having clamping protrusions and recesses coupled with each other according to another embodiment of the present invention disclosure;

FIGS. 13 through 19 are perspective views of main bodies and opening/closing members implemented as lever members according to embodiments of the present disclosure;

FIGS. 20 and 21 are perspective views of opening/closing members implemented as pulling members according to embodiments of the present disclosure;

FIG. 22 is a perspective view of a main body and an opening/closing member separated from each other according to an embodiment of the present disclosure;

FIG. 23 is an exploded perspective view of a locking member and coupling members for coupling a cover member with a main body according to an embodiment of the present disclosure;

FIG. 24 is a perspective view of a lock with a number-controlled lock/release portion according to an embodiment of the present disclosure;

FIG. 25 is a perspective view of a main body and a cover member engaged with the main body so as to enclose a part of the main body according to an embodiment of the present disclosure;

FIG. 26 is an exploded perspective view of a main body and a cover member sliding with respect to the main body according to an embodiment of the present disclosure;

FIG. 27 is a perspective view of a locking apparatus including connecting bars and pressing portions according to another embodiment of the present disclosure;

FIG. 28 is a perspective view of another example of the lever member in the locking apparatus of FIG. 27;

FIG. 29 is a side view of another example of the pressing portions in the locking apparatus of FIG. 27;

FIG. 30 is a perspective view of a locking apparatus having a clipping mechanism according to another embodiment of the present disclosure;

FIG. 31 is a cross-section of the locking apparatus of FIG. 30;

FIGS. 32 and 33 illustrate examples of directly binding an article with a locking apparatus having a clipping mechanism according to an embodiment of the present disclosure;

FIGS. 34 and 35 illustrate examples of securing an article with a locking apparatus having a clipping mechanism chain connected to the article; and

FIG. 36 is a state diagram illustrating a locking apparatus with a clipping mechanism includes a cover member designed in a bag shape.

### DETAILED DESCRIPTION OF EXEMPLARY EMBODIMENTS

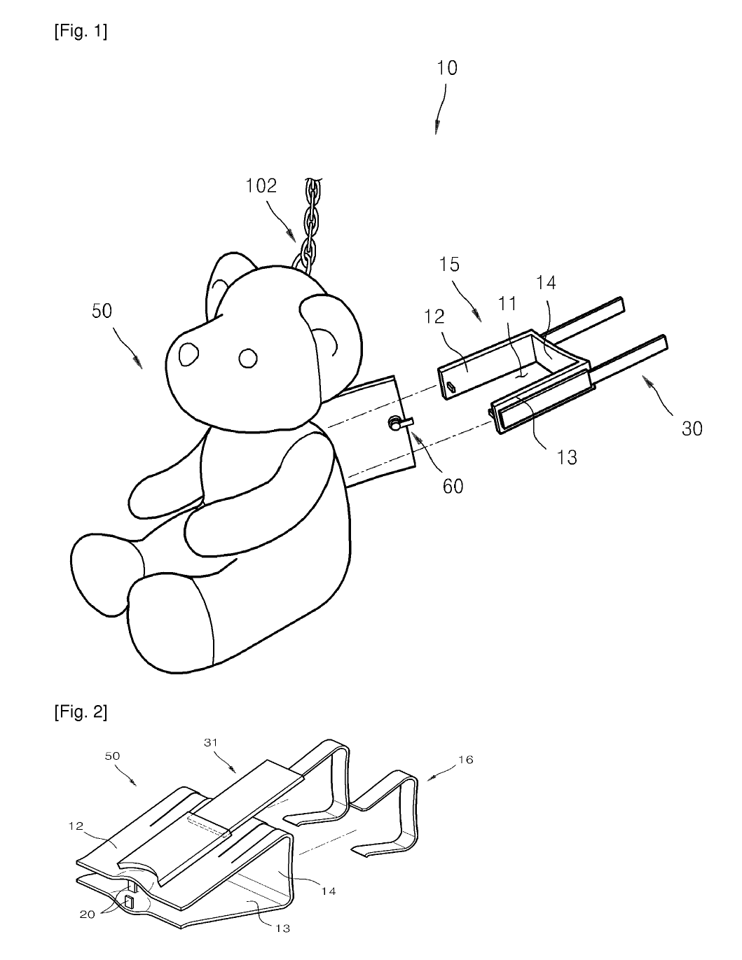

A locking apparatus having a clipping mechanism according to the present disclosure can be applied to any device that is vulnerable to privacy intrusions. A locking apparatus can be used not only in securing an article but also in creating a functional design using characters. FIG. 1 is an exploded perspective view of a locking apparatus 10 with a character doll-like cover member according to an embodiment of the present disclosure.

Referring to FIG. 1, the locking apparatus 10 having a clipping mechanism includes a main body 15 consisting of upper and lower pressing portions 12 and 13 defining a gripping space and a support providing a proper gripping force to the upper and lower pressing portions 12 and 13, an opening/closing member 30 that is affixed to the main body 15 and transmits a force to the upper and lower pressing portions 12 to open the upper and lower pressing portions 12 and 13, a leverage-like lever member 31 disposed on at least one of the upper and lower pressing portions 12 and 13 so as to easily apply a force to the opening/closing member 30, a cover member 50 that enclose at least a portion of the inside and outside of the main body 15 and controls application of a force to open the upper and lower pressing portions 12 and 13, and a locking member 60 that is disposed at a location on the cover member 50 where the cover member 50 and the main body 15 interact with each other. Here, the locking member 60 also smoothly opens or closes the main body 15 and the cover member 50.

Components in the locking apparatus having the above-mentioned configuration according to the present embodiment are described in more detail with reference to FIGS. 1 and 2.

Referring to FIGS. 1 and 2, the main body 15 has a clip- or clipping mechanism to pinch an article. The main body 15 is formed by bending an elastic portion-like body. The upper and lower pressing portions 12 and 13 have ends that are held in contact with each other. The support 14 determines a volume that can be gripped and may have varying heights and widths. In particular, the main body 15 may also be made of different materials such as elastic portion, synthetic resin, or wire into various shapes.

As shown in FIG. 2, an elastic reinforcement member 16 or reinforcement bead (not shown) is bonded to the support 14 in order to increase the gripping force. The elastic reinforcement member 16 may be formed of an elastic material surrounding the inside and outside of the main body 15, but is not limited thereto.

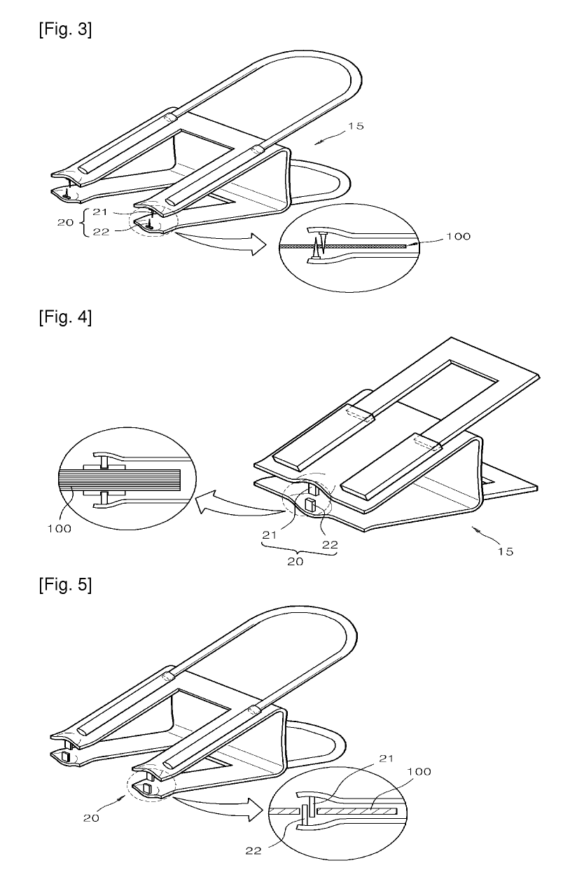

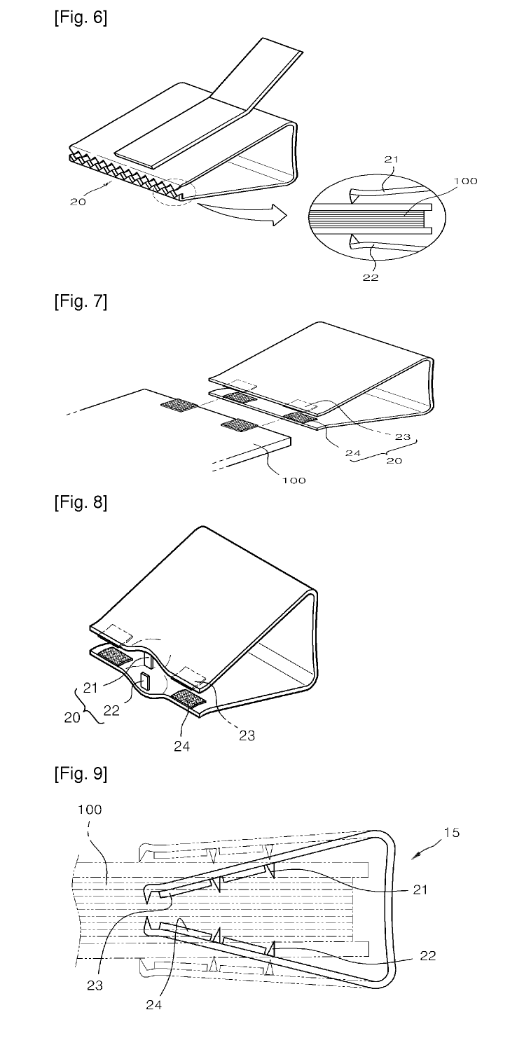

A friction-induced portion 20 is disposed at a distal end of the main body 15 so as to prevent the upper and lower pressing portions 12 and 13 from sliding or being separated from a portion of an article being bound. Referring to FIGS. 3 through 6, the friction-induced portion 20 includes a first protrusion 21 disposed downwardly from a distal end or inner surface of the upper pressing portion 12 and a second protrusion 22 disposed upwardly from a distal end or inner surface of the lower pressing portion 13. Referring to FIGS. 3 and 5, the first and second protrusions 21 and 22 have sharp ends and may be interlaced with each other to prevent interference therebetween. The sharp protrusions 21 and 22 are fixed to a portion of an article to be bound by perforating the portion of the article.

In order to reduce interference between the first and second protrusions 21 and 22 as shown in FIGS. 4 and 5, portions of the upper and lower pressing portions 12 and 13 in which the first and second protrusions 21 and 22 are formed may be separated from each other by a greater distance than the remaining portion thereof.

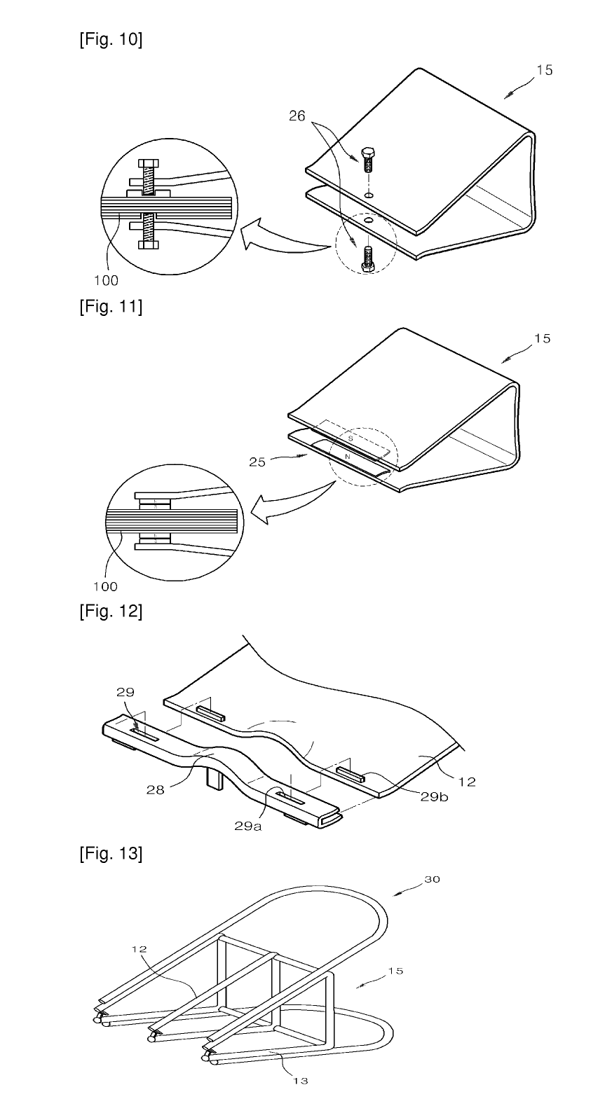

Depending on the type of application, the first and second protrusions 21 and 22 may be integrated with the main body 15 or engaged therewith using screw tightening or other various methods. As shown in FIG. 10, the first and second protrusions 21 and 22 may be formed so as to adjust their heights, i.e., by coupling adjusting screws 26 in holes in the distal ends of the upper and lower pressing portions 12 and 13.

Referring to FIGS. 7 and 8, the friction-induced portion 20 consists of first and second pads 23 and 24 that are disposed on opposing inner surfaces of the upper and lower pressing portions 12 and 13 and prevents sliding when binding an article 100. The first and second pads 23 and 24 may have different configuration depending on a location of an article to be bound. The pads 23 and 24 may be formed of a high friction material such as soft rubber or Velcro tape and have a plurality of grooves and bosses thereon to increase a friction force therebetween.

The first and second pads 23 and 24 may be affixed using an adhesive, screw tightening, or other various methods depending on the materials of the first and second pads 23 and 24 and the main body 15. Referring to FIG. 8, the friction-induced portion 20 may consist of a combination of the first and second protrusions 21 and 22 and the first and second pads 23 and 24, but is not limited thereto. The friction-induced portion 20 may be bent into a waveform so that the upper and lower pressing portions 12 and 13 are engaged with each other. Referring to FIG. 11, the friction-induced portion 20 may have permanent magnets affixed thereon. Referring to FIG. 12, support brackets 28 having the first and second protrusions and the first and second pads thereon are respectively engaged with the distal ends of the upper and lower pressing portions, thereby making it easy to install and use the first and second protrusions and the first and second pads. The support brackets 28 are engaged with the upper and lower pressing portions by engagement members 29. Each engagement member 29 includes engagement recesses 29a formed in the support bracket 28 and engagement bosses 29b formed on the upper or lower pressing portion.

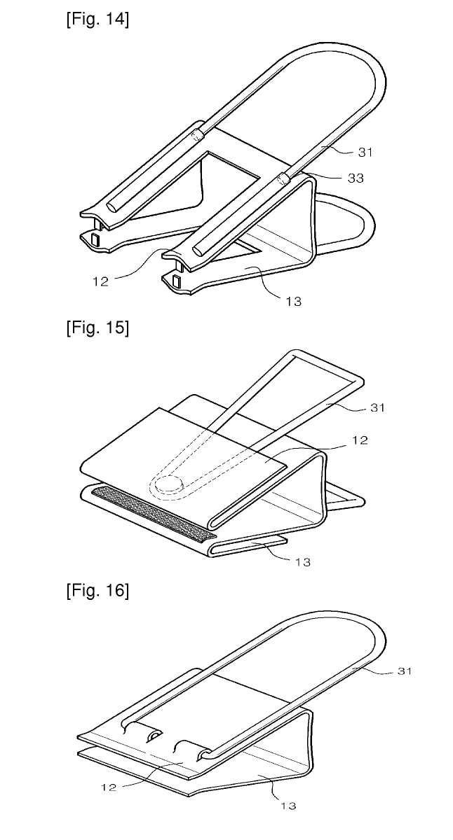

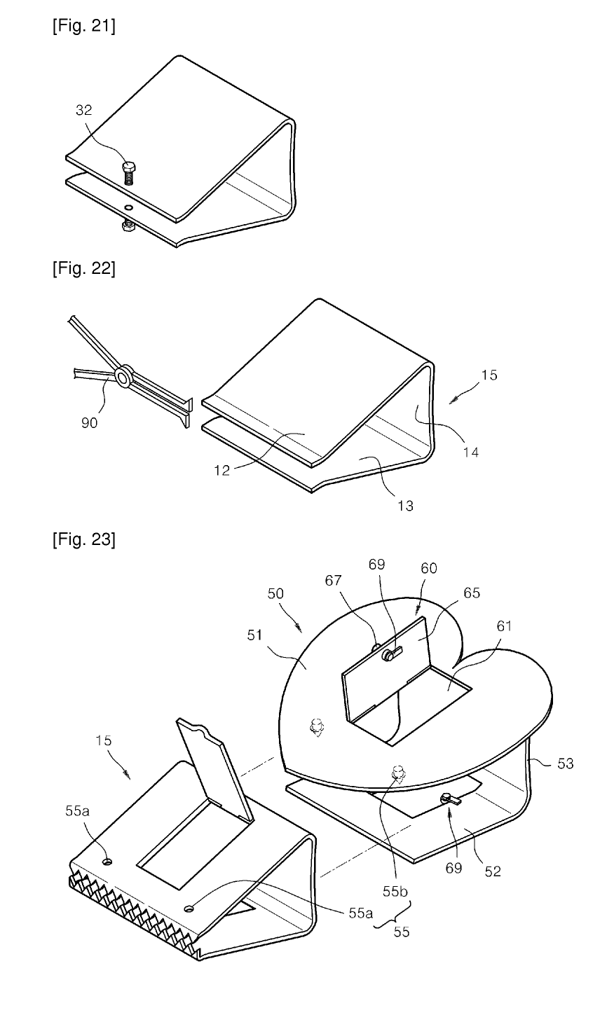

The opening/closing member 30 is provided in the main body 15 and transfers a force for opening the upper and lower pressing portions 12 and 13 to the upper and lower pressing portions 12 and 13. The opening/closing member 30 may have various shapes as illustrated in FIGS. 13 through 19 and FIGS. 20 and 21. Referring to FIGS. 20 through 22, an opening/closing member may be a pulling member 32 that allows a user to apply a force to the upper and lower pressing portions with his/her hands or tools. As illustrated in FIGS. 13 through 18, an opening/closing member may be a lever member 31 that assists facilitate the application of a force to the upper and lower pressing portions 12 and 13. Further, as illustrated in FIG. 19, an opening/closing member may be a lever member shaped to press up and down the upper and lower pressing portions 12 and 13. Referring to FIG. 22, if the main body 15 does not include an opening/closing member, the user inconveniently has to use a separate opening/closing tool 90 to open the upper and lower pressing portions 12 and 13. Conversely, the main body 15 with an opening/closing member is convenient to use. Referring to FIGS. 14 and 18, the portion- or rod-like lever member 31 is slidably mounted in a guide groove 33 provided in the upper or lower pressing portion 12 or 13. The guide groove 33 may be formed by beading or in a separate guide member.

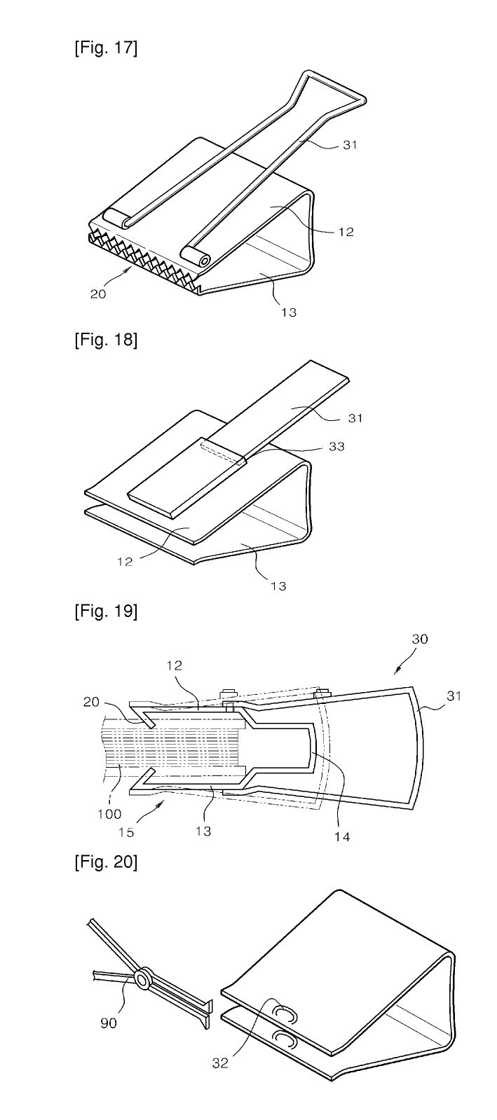

The lever member 31 is not limited thereto but may be movably or rotatably affixed to at least one of the upper and lower pressing portions 12 and 13 as illustrated in FIGS. 15 through 17. The lever member 31 may be formed by lancing the upper or lower pressing portion 12 or 13. As illustrated in FIGS. 16 and 17, the lever member 31 may be made of wires. In this case, ends of the lever member 31 are hinged to the upper or lower pressing portion 12 or 13.

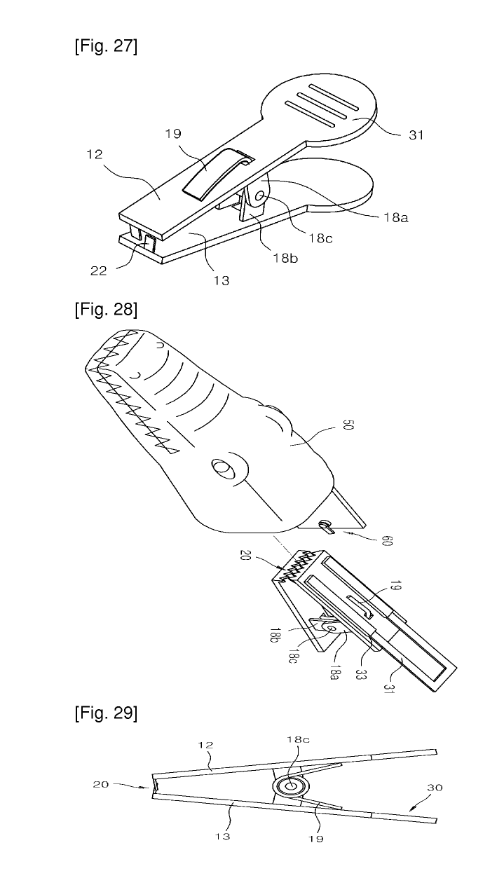

Meanwhile, as shown in FIGS. 27 through 29, the main body may include opposing connecting bars 18a and 18b disposed at rear ends of the upper and lower pressing portions 12 and 13 and hinged on a hinge axis 18c. Here, the main body may include a pressing member 19 affixed thereto so as to provide a gripping force to the upper and lower pressing portions 12 and 13.

The pressing member 19 may be realized as an elastic member such as a lead spring, coil spring, or torsion spring that interacts with the upper and lower pressing portions 12 and 13, but is not limited thereto.

Another example of the pressing member 19 may be a mechanical member that is mounted on the connecting bars 18a and 18b so as to increase the distance between the upper and lower pressing portions 12 and 13. The mechanical member has a built-in power unit (not shown) generating a force such as a motor that operates to increase the distance between the upper and lower pressing portions 12 and 13. The main body including the connecting bars 18a and 18b and the pressing member 19 may be used instead of the main body 15 having a self-elastic, gripping force. The lever member 31 extending beyond the ends of the upper and lower pressing portions 12 and 13 may be integrated with the upper and lower pressing portions 12 and 13, but are not limited thereto. That is, as in an embodiment shown in FIG. 28, separate lever members 31 may be connected with the upper and lower pressing portions 12 and 13. The opening/closing member may be the pulling member 32. Unlike the embodiment shown in FIG. 22, the main body may not include an opening/closing member. The friction-induced portion 20 may be disposed at ends of the upper and lower pressing portions 12 and 13 and the formation and function of the friction-induced portion 20 will not be described specifically in order to avoid redundancy.

Referring to FIGS. 1 and 23, the cover member 50 encloses at least a portion of the inside and outside of the main body 15 and controls application of a force to open the upper and lower pressing portions 12 and 13. As in the embodiment shown in FIG. 23, the cover member 50 includes a first cover member 51 enclosing the upper pressing portion 12, a second cover member 52 enclosing the lower pressing portion 13, and a third cover member 53 connecting the first cover member 51 with the second cover member 52. The cover member 50 is not limited thereto and may directly enclose only a portion of the main body 15, i.e., the opening/closing member 50 as shown in FIG. 25. In addition to the cover member 50 according to the above-described embodiments, the cover member 50 may also enclose the inside of the main body, as shown in FIG. 25, as well as the outside thereof, as shown in FIG. 1.

Alternatively, the cover member 50 may further include a locking member 60 disposed at a location where the cover member 50 and the main body 15 interact with each other and capable of smoothly opening/closing the main body 15 and the cover member 50 enclosing the main body 15.

As illustrated in FIGS. 1, 23, and 25, the locking member 60 may be configured to control exposure of the opening/closing member when the main body 15 is engaged with the cover member 50. Alternatively, as shown in FIG. 26, the locking member 60 may be configured to expose the opening/closing member when the cover member 50 slides with respect to the main body 15.

Examples of the locking member 60 incorporated into the cover member 50 fixedly coupled to the main body 15 are illustrated in FIGS. 1 and 23.

As shown in the drawings, the locking member 60 includes an aperture 61 through which the lever member as an opening/closing member is exposed to the first and second cover members 51 and 52 or the third cover member 53, a door 65 that is disposed in the first through third cover members 51 through 53 so as to open or close the aperture 61, and a lock 67 mounted on the door 65 so as to lock the door 65. The lock 67 includes a lock body mounted on an edge of the door 65 and having a lock/release portion and a latch member 69 extending along an axis of the lock/release portion and locking into the aperture 61. Here, the main body 15 may be engaged with the cover member 50 by separate coupling means 55. The coupling means 55 includes coupling holes 55a formed in the main body 15 and coupling hooks 55b formed at a location in the cover member 50 corresponding to the coupling holes 55a. The coupling means 55 are not limited thereto and may be realized in other various ways, i.e., by molding the main body 15 with the cover member 50 or bonding the main body 15 to the cover member 50 using an adhesive depending on the material of the main body 15 and the cover member 50. The door 65 and the lock 67 may be mounted in the first and second cover members 51 and 52 depending on the design of the cover member 50.

FIG. 26 illustrates a modified example of the locking member mounted on the cover member 50 that slides with respect to the main body 15 so as to expose the opening/closing member according to another embodiment of the present disclosure.

Referring to FIG. 26, the locking member secures the cover member 50 moving relative to the main body 15 and includes a lock 71 mounted on an edge of the cover member 50. The lock 71 includes a lock body 72 mounted on the edge of the cover member 50 and having a lock/release portion and a latch member 74 extending along an axis of the lock/release portion and selectively inserted into a hole 73 formed in the main body 15.

The main body 15 and the cover member 50 further include a guide portion 75 that allows the cover member 50 to slide with respect to the main body 15. The guide portion 75 includes a guide groove 75a formed in at least one of the upper and lower pressing portions 12 and 13 and a guide boss 75b formed at a location in the cover member 50 corresponding to the guide groove 75a. That is, the guide portion 75 is configured such that the guide boss 75b slides along the guide groove 75a.

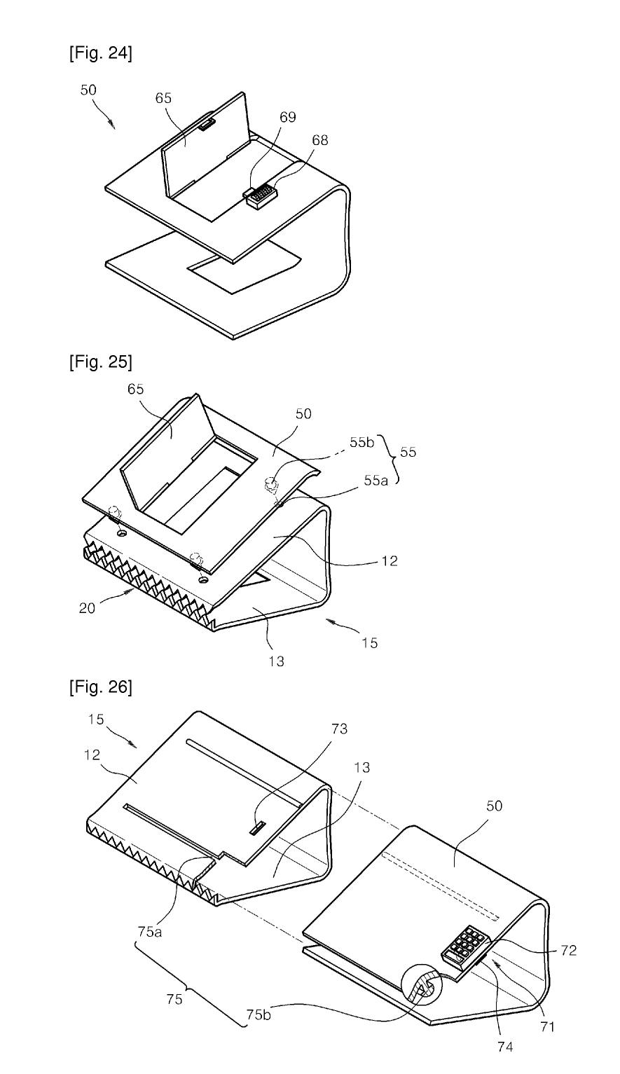

Referring to FIGS. 23, 24, and 26, the lock 67 (71) includes the lock body 68 (72) having the lock/release portion and the latch member 69 (74). The lock 67 (71) may be locked or released by inserting a key into the lock/release portion as shown in FIG. 23 or by manipulating the number-controlled lock/release portion with a preset number as shown in FIGS. 24 and 26. Since a lock is well known in the art, the configuration and operation of the lock will not be described in detail.

The cover member 50 engaged with the main body 15 may have various character doll-like shapes to achieve aesthetic accessory functions and ornamental effects. In order to facilitate manufacturability, figures of animals and flowers, photos, or jewels may be attached to a preformed cover member.

According to the embodiment shown in FIGS. 27 through 29, the locking apparatus includes a main body 15 having upper and lower pressing portions 12 and 13 defining a gripping space and connecting bars 18a and 18b connecting the upper and lower pressing portions 12 and 13 with each other, and a pressing member 19 affixed thereto so as to provide a gripping force to the upper and lower pressing portions 12 and 13. Since the formation and function of the cover member 50 and the locking member are substantially the same as described above in the previous embodiment, detailed explanations will not be given.

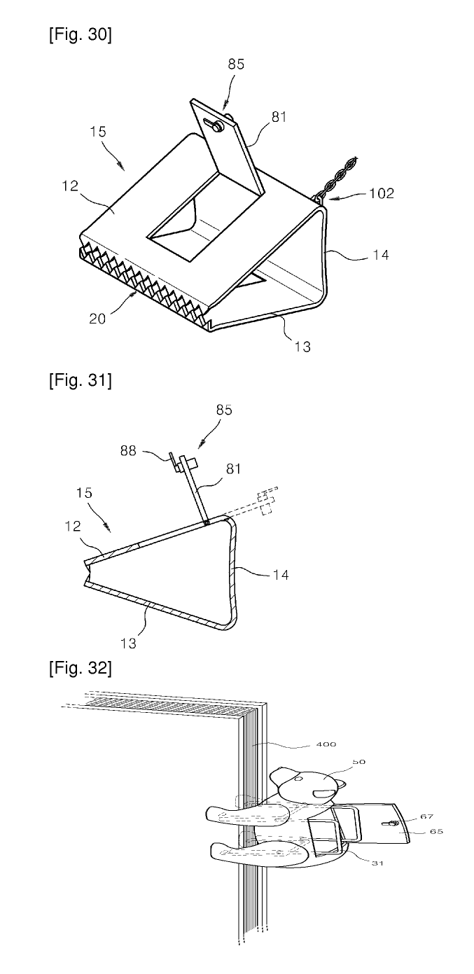

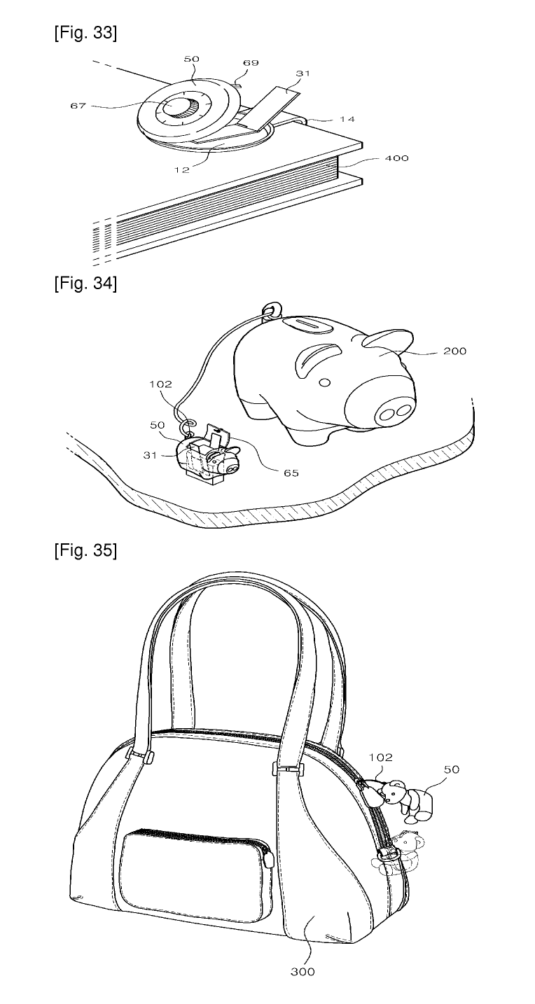

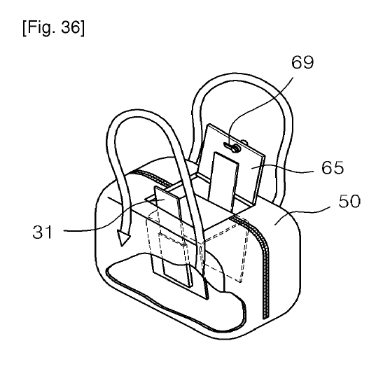

Another examples of FIGS. 30 and 31 illustrate a locking apparatus having a clipping mechanism according to another embodiment of the present disclosure. Like numbers refer to like members. Referring to FIGS. 30 and 31, the locking apparatus according to the current embodiment includes a main body 15 and an opening/closing member. The main body 15 includes upper and lower pressing portions 12 and 13 defining a gripping space and a support 14 providing a proper gripping force to the upper and lower pressing portions 12 and 13. The opening/closing member is affixed to the main body 15 and transmits a force to the upper and lower pressing portions 12 and 13 so that the upper and lower pressing portions 12 and 13 may open. Here, the opening/closing member includes a leverage-type lever member 81 disposed on the upper and lower pressing portions 12 and 13 so as to easily apply a force to the opening/closing member. In addition, a locking member 85 is disposed at a location where the main body 15 and the lever member 81 interact with each other. Here, the locking member 85 also secures the lever member 81. The locking member 85 includes a lock locking the lever member 81 and controlling the operation of the lever member 81, and a guide member (not shown) guiding the movement of the lock. The lock includes a lock body having on an inner side a lock/release portion of a sufficient size to control the operation of the lever member 81 and a latch member 88 extending along an axis of the lock/release portion.

The lock is mounted on the lever member 81 configured to be rotated for folding down. The lever member 81 is fastened with the latch member 88 when rotated and folded down on the main body 15.

In an alternative embodiment, the locking member may control the operation of the lever member 81 using a guide member (not shown) provided at one side of the main body 15. The guide member includes a guide groove formed at one side of the main body 15 and a guide protrusion formed at a location in the lock body corresponding to the guide groove. The guide protrusion slidably moved into the lever member 81 along the guide groove. Then, the lever member 81 is locked in the lock body so that it cannot operate properly.

Like in embodiments of the present disclosure described above, the main body 15 may have a friction-induced portion 20 on an inner surface thereof. Since the configuration, formation method, and operation are substantially the same as those of the previous embodiment, except for the friction-induced portion 20, a detailed explanation thereof will not be given.

In an alternative embodiment, the locking apparatus, which includes a main body having upper and lower pressing portions 12 and 13 defining a gripping space and connecting bars 18a and 18b connecting the upper and lower pressing portions 12 and 13 with each other, and a pressing member 19 affixed thereto so as to provide a gripping force to the upper and lower pressing portions 12 and 13, may include a locking member having substantially the same configuration as described above in the previous embodiment. In this case, since the configuration, formation method, and operation of the locking member are substantially the same as described above in the previous embodiment, detailed descriptions thereof will be omitted.

As illustrated in FIGS. 1, 34, and 35, a main body or cover member is provided with a chain 102 with a connecting ring for connecting a locking apparatus having a clipping mechanism with an article 100. The chain 102 further has a separate fixing member at an end thereof in order to fix the end of the chain 102 to the article 100. The chain 102 may extend outward using a string or bar and be wound on a reel (not shown) disposed in the article 100.

The operation of the locking apparatus with a clipping mechanism 10 having the above-mentioned configuration is described in detail.

Referring to FIGS. 1, 32, 34, and 35, in order to secure or protect a piggy bank 200, a zipper of a bag 300, and a notebook 400 from privacy intrusions or theft, a lock 67 (86) is opened and then a lever member 31 that is an opening/closing member slides with respect to the upper and lower pressing portions 12 and 13 so that ends of the lever member 31 extend beyond the ends of the upper and lower pressing portions 12 and 13. The lever member 31 is used to open the upper and lower pressing portions 12 and 13 and a gripping space. A portion of an article to be secured such as the piggy bank 200, the bag 300, and the notebook 400 is then inserted into the gripping space for binding. An article to be indirectly bound and secured, such as the piggy bank 200 and zipper of the bag 300, is connected to the locking apparatus 10 through the chain 102.

When the portion of the article is inserted into the gripping space for binding, an external force applied to the lever member 31 is removed so that the portion of the article is gripped by the upper and lower pressing portions 12 and 13. The friction-induced portion 20 such as the first and second protrusions (21 and 22 in FIG. 3) or the first and second pads (23 and 24 in FIG. 7) is disposed on opposing surfaces of the upper and lower pressing portions 12 and 13 so as to prevent the main body 15 from being separated from the portion of the article being bound. After binding the article to the locking apparatus, the lever member 31 slides back into the original position and the door 65 in the cover member 50 is closed by the lock 67 so that the lever member 31 cannot be seen (see FIG. 1). Alternatively, the cover member 50 may slide with respect to the main body 15 so as not to expose the lever member 31 and the lock 67 (86) is used to lock the cover member 50 moving relative to the main body 15 (see FIG. 26). Meanwhile, the lever member shown in FIG. 28 is constructed such that a main body consists of connecting bars 18a, 18b and 18c, and the lever member shown in FIG. 31 is constructed such that a locking member 85 directly secures the lever member 81. Since the lever members shown in FIGS. 28 and 31 are substantially the same as described above in the previous embodiment, detailed descriptions thereof will be omitted.

As described above, the locking apparatus having a clipping mechanism according to the present disclosure can be easily applied to personal articles suffering difficulty in installing the locking apparatus such as a notebook, a bag, a book, or a zipper. In addition, the locking apparatus having a clipping mechanism according to the present disclosure can have various shapes to achieve aesthetic accessory functions and ornamental effects. In particular, the locking apparatus can be easily applied to personal articles vulnerable to privacy intrusions, thereby providing improved market quality.

While the present disclosure has been particularly shown and described with reference to exemplary embodiments thereof, it will be understood by those skilled in the art that various changes in form and details may be made therein without departing from the spirit and scope of the present disclosure as defined by the following claims and equivalents thereof.

A locking apparatus having a clipping mechanism according to the present disclosure can be widely applied to usefully lock or secure personal articles vulnerable to privacy intrusions such as a bag, a notebook, a planner/diary, and a book and an electronic dictionary, a gaming machine or other electronic devices vulnerable to theft. The locking apparatus according to the present disclosure also has flexibility in selecting a wide range of alternative materials and designs while providing a sense of physical, psychological security to consumers and improved market quality.

1. A locking apparatus having a clipping mechanism, the device comprising:
a main body including upper and lower pressing portions defining a gripping space and a support supporting the upper and lower pressing portions and providing a gripping force to the upper and lower pressing portions; and
a cover member enclosing the main body and controlling a force for opening the upper and lower pressing portions to the main body.

2. The locking apparatus of claim 1, further comprising an opening/closing member that is affixed to the main body and transmits a force to the upper and lower pressing portions so that the upper and lower pressing portions may open.

3. The locking apparatus of claim 1, further comprising a locking member that is disposed on the main body and the cover member and locks the cover member moving relative to the main body.

4. The locking apparatus of claim 1, further comprising a friction-induced portion that is disposed on the upper and lower pressing portions so as to prevent the upper and lower pressing portions from sliding or being separated from a portion of an article being bound.

5. The locking apparatus of claim 2, wherein the opening/closing member further comprises a leverage-type lever member disposed on at least one of the upper and lower pressing portions so as to easily apply a force to the opening/closing member.

6. The locking apparatus of claim 3, wherein the locking member comprises a door that is disposed in the cover member so as to control the operation of the cover member and opens or closes only a portion of the cover member so that only a portion of the main body is exposed and a lock mounted at a location where the cover member interacts with the door so as to lock opening/closing of the door.

7. The device of claim 3, wherein the locking member comprises a guide portion that is formed in the main body and the cover member so that the cover member slides transversely with respect to the main body and assists opening and closing of the cover member and a lock mounted at a location where the cover member interacts with the cover member so as to lock opening/closing of the cover member.

8. The locking apparatus of claim 5, further comprising:
a locking member that is disposed at a location where the cover member enclosing the main body interacts with the main body and smoothly opens or closes the main body and the cover member, wherein the locking member includes a door that is disposed in the cover member so as to control the operation of the cover member and opens or closes only a portion of the cover member so that only a portion of the main body is exposed and a lock mounted at a location where the cover member interacts with the door so as to lock opening/closing of the door;
a friction-induced portion that is disposed on the upper and lower pressing portions so as to prevent the upper and lower pressing portions from sliding or being separated from a portion of an article being bound, wherein the friction-induced portion includes protrusions installed on inner surfaces of the upper and lower pressing portions so as to prevent separation of the upper and lower pressing portions and anti-sliding pads; and
an elastic reinforcement member bonded to the main body so as to increase a gripping force of the upper and lower pressing portions; and a chain secured to the cover member and connecting the cover member with the article.

9. The locking apparatus of claim 5, further comprising:
a locking member that is disposed at a location where the cover member enclosing the main body interacts with the main body and smoothly opens or closes the main body and the cover member, wherein the locking member includes a guide portion that is formed in the main body and the cover member so that the cover member slides transversely with respect to the main body and assists opening and closing of the cover member and a lock mounted at a location where the cover member interacts with the main body so as to lock opening/closing of the cover member;
a friction-induced portion that is disposed on the upper and lower pressing portions so as to prevent the upper and lower pressing portions from sliding or being separated from a portion of an article being bound, wherein the friction-induced portion includes protrusions installed on inner surfaces of the upper and lower pressing portions so as to prevent separation of the upper and lower pressing portions and anti-sliding pads; and
an elastic reinforcement member bonded to the main body so as to increase a gripping force of the upper and lower pressing portions; and a chain secured to the cover member and connecting the cover member with the article.

10. The locking apparatus of claim 7, further comprising a friction-induced portion that is disposed on the upper and lower pressing portions so as to prevent the upper and lower pressing portions from sliding or being separated from a portion of an article being bound.

11. A locking apparatus having a clipping mechanism, the device comprising:
a main body including upper and lower pressing portions defining a gripping space and connecting bars connecting the upper and lower pressing portions with each other;
a pressing member affixed to the main body so as to provide a gripping force to the upper and lower pressing portions; and
a cover member enclosing the main body and controlling a force for opening the upper and lower pressing portions to the main body.

12. The locking apparatus of claim 11, further comprising an opening/closing member that is affixed to the main body and transmits a force to the upper and lower pressing portions so that the upper and lower pressing portions may open.

13. The locking apparatus of claim 11, further comprising a locking member that is disposed on the main body and the cover member and locks the cover member moving relative to the main body.

14. The locking apparatus of claim 11, further comprising a friction-induced portion that is disposed on the upper and lower pressing portions so as to prevent the upper and lower pressing portions from sliding or being separated from a portion of an article being bound.

15. The locking apparatus of claim 12, wherein the opening/closing member further comprises a lever member disposed on at least one of the upper and lower pressing portions so as to easily apply a force to the opening/closing member.

16. The locking apparatus of claim 13, wherein the locking member comprises a door that is disposed in the cover member so as to control the operation of the cover member and opens or closes only a portion of the cover member so that only a portion of the main body is exposed and a lock mounted at a location where the cover member interacts with the door so as to lock opening/closing of the door.

17. The locking apparatus of claim 13, wherein the locking member comprises a guide portion that is formed in the main body and the cover member so that the cover member slides transversely with respect to the main body and assists opening and closing of the cover member and a lock mounted at a location where the cover member interacts with the cover member so as to lock opening/closing of the cover member.

18. The locking apparatus of claim 15, further comprising:
a locking member that is disposed at a location where the cover member enclosing the main body interacts with the main body and smoothly opens or closes the main body and the cover member, wherein the locking member includes a door that is disposed in the cover member so as to control the operation of the cover member and opens or closes only a portion of the cover member so that only a portion of the main body is exposed and a lock mounted at a location where the cover member interacts with the door so as to lock opening/closing of the door;
a friction-induced portion that is disposed on the upper and lower pressing portions so as to prevent the upper and lower pressing portions from sliding or being separated from a portion of an article being bound, wherein the friction-induced portion includes protrusions installed on inner surfaces of the upper and lower pressing portions so as to prevent separation of the upper and lower pressing portions and anti-sliding pads; and
an elastic reinforcement member bonded to the main body so as to increase a gripping force of the upper and lower pressing portions; and a chain secured to the cover member and connecting the cover member with the article.

19. The locking apparatus of claim 15, further comprising:
a locking member that is disposed at a location where the cover member enclosing the main body interacts with the main body and smoothly opens or closes the main body and the cover member, wherein the locking member includes a guide portion that is formed in the main body and the cover member so that the cover member slides transversely with respect to the main body and assists opening and closing of the cover member and a lock mounted at a location where the cover member interacts with the main body so as to lock opening/closing of the cover member;
a friction-induced portion that is disposed on the upper and lower pressing portions so as to prevent the upper and lower pressing portions from sliding or being separated from a portion of an article being bound, wherein the friction-induced portion includes protrusions installed on inner surfaces of the upper and lower pressing portions so as to prevent separation of the upper and lower pressing portions and anti-sliding pads; and
an elastic reinforcement member bonded to the main body so as to increase a gripping force of the upper and lower pressing portions; and a chain secured to the cover member and connecting the cover member with the article.

20. The locking apparatus of claim 17, further comprising a friction-induced portion that is disposed on the upper and lower pressing portions so as to prevent the upper and lower pressing portions from sliding or being separated from a portion of an article being bound.

21. A locking apparatus having a clipping mechanism, the device comprising:
a main body including upper and lower pressing portions defining a gripping space and a support supporting the upper and lower pressing portions and providing a gripping force to the upper and lower pressing portions;
an opening/closing member that is affixed to the main body, transmits a force to the upper and lower pressing portions so that the upper and lower pressing portions may open, and further includes a lever member disposed on the upper and lower pressing portions so as to easily apply a force to the opening/closing member; and
a locking member that is disposed at a location where the main body interacts with the lever member and controls the operation of the lever member, wherein the locking member includes a lock disposed on the main body and the lever member and secures and locks the operation of the lever member.

22. A locking apparatus having a clipping mechanism, the device comprising:
a main body including upper and lower pressing portions defining a gripping space and connecting bars connecting the upper and lower pressing portions with each other;
a pressing member affixed to the main body so as to provide a gripping force to the upper and lower pressing portions;
an opening/closing member that is affixed to the main body, transmits a force to the upper and lower pressing portions so that the upper and lower pressing portions may open, and further includes a lever member disposed on the upper and lower pressing portions so as to easily apply a force to the opening/closing member; and
a locking member that is disposed at a location where the main body interacts with the lever member and controls the operation of the lever member, wherein the locking member includes a lock disposed on the main body and the lever member and secures and locks the operation of the lever member.
